(19) United States
(12) Patent Application Publication
(10) Pub. No.: US 2008/0057282 A1
(43) Pub. Date: Mar. 6, 2008

(54) Biomass densifier apparatus

(76) Inventors: Robert L. Bishop, Midland, MI (US); Jacob P. Bishop, Midland, MI (US)

Correspondence Address: MCKELLAR IP LAW, PLLC, 784 SOUTH POSEYVILLE ROAD, MIDLAND, MI, 48640, US

(21) Appl. No.: 11/894,322

(22) Filed: Aug. 21, 2007

Related U.S. Application Data
(60) Provisional application No. 60/841,461, filed on Aug. 30, 2006.

(51) Int. Cl. B29C 31/00

(52) U.S. Cl. 428/219; 425/449; 425/62

(57) ABSTRACT

A portable extruding apparatus that is capable of densifying biomass to greater densities and higher caloric values than has been possible heretofore. This capability is possible through the use of a vented barrel on the end of the extruder that allows for the escape of any gasses that are built-up during the compression and densification process without loss of any of the densifying material through the vents of the barrel during the processing.

This application claims priority from U.S. Provisional Patent Application No. 60/841,461 filed Aug. 30, 2006.

The instant invention deals with a portable, vertical and horizontal extruding apparatus that is capable of densifying biomass to greater densities having higher British Thermal Unit (btu) potential than has been possible heretofore by using higher btu feed stock. This capability is possible through the use of a vented barrel that allows for the escape of any gasses that are built-up during the compression and densification process. The vents allow the compaction of high btu products by allowing the escape of gasses created by friction during the compression process

### BACKGROUND OF THE INVENTION

This invention deals with an extruding apparatus that is capable of densifying biomass to greater densities than has been possible heretofore. This invention allows the processing of material with heat content as high as 12,000 btu/lb., which is hotter than almost all coal used today, and, more importantly, much cleaner, that is, ultra low sulfur, low mercury and carbon dioxide neutral.

Pelletizing biomass, especially wood products, has been used in the United States for a long time. A high degree of compaction, that is, densification, and pellet toughness, that is, a pellet's resistance to disintegration, are the desired properties of a commercial pellet product.

Most prior art pelletizers and densification apparatii attempt to extrude particulate matter through a die of relative short barrel length. In such equipment, the particles are exposed to the compacting, shaping and densification forces in the barrel for only a short time.

As early as 1892, in U.S. Pat. No. 474,412, continuous production of pellets to bricks that were used as fuel was disclosed. This disclosure dealt with particulate matter that was coal dust mixed with a binder, such a mixture being fed between converging belts and compacted into briquettes that were ultimately transported and burned.

In 1940, U.S. Pat. No. 2,194,593 was issued to Graham and addressed a machine for compacting and densifying sawdust into briquettes for consumption in a heating apparatus. Very importantly, Graham recognized the now well-known principle that wood particulates contain sufficient natural resins, pitch and the like, that can be used for particle binding purposes, if enough heat and pressure are applied to activate them, that is, render the particulates “plastic”. Evenso, the briquettes derived by this method were not overly compacted owing to the fact that belts were used to do the compacting and had limited pressure on the particulate materials.

One of the main reasons that extruders have not been extensively used for highly densified materials is the fact that the extruder is “contained”, that is, relatively little air or other gasses can escape from the barrel of the extruder and this results in high and dangerous pressure within the barrel. It was thought that the barrel could not be vented because of the fact that it was believed that the material being extruded would exit from any vents or openings that were placed in the barrel to relieve pressure.

Contrary to this popular belief, it has been found that such openings can be placed in the extruder barrel to allow gasses to escape without the extruded material exiting through these openings. This results in highly densified materials without the dangers of high pressure.

### SUMMARY OF THE INVENTION

This invention deals with an extruding apparatus that is capable of densifying biomass to greater densities than has been possible heretofore. Such an apparatus is an extruder having a barrel that has vents or openings cut through it to allow for the escape of gasses that are built up during the heating and extrusion process.

Thus, this invention deals with a densifying apparatus for densifying biomass. The apparatus comprises a support frame and mounted to the support frame is an extruder. The extruder has an extruder housing, a bearing housing having a front wall and a back wall, a feed hopper, and a vented barrel having a long axis. By “long axis” it is meant that the axis is centered in the barrel and runs the long length of the barrel. The extruder housing has mounted and supported therein, an extruder screw, the extruder screw comprising an extruder shaft, an auger segment mounted on the extruder shaft, a first end, a second end, and a middle zone.

The extruder shaft has mounted on the first end, a means for connecting to a drive means, and the extruder shaft terminates near the second end. The auger segment is mounted near the middle zone. The bearing housing is located between the extruder housing and the first end of the extruder shaft and the extruder shaft is supported by a thrust bearing located near the bearing housing front wall and a roller bearing located near the bearing housing back wall.

The vented barrel is mounted on a support wall and is centered such that it encloses the extruder shaft, the vent barrel being in linear alignment along the long axis with the extruder shaft.

There is a pressure clamp encircling the vented barrel and a hopper mounted on the extruder housing such that the biomass can be delivered to the auger segment of the extruder screw.

### BRIEF DESCRIPTION OF THE DRAWINGS

FIG. 1 is a view in perspective of an apparatus of this invention shown mounted on a frame and the frame in turn mounted on a set of wheels.

FIG. 2 is a cross sectional view of the apparatus of FIG. 1 taken through line A-A.

FIG. 3 is an enlarged side view of a portion B of the apparatus of FIG. 2 with the wheel missing from the front side to ensure clarity and showing a motor and belt driven apparatus.

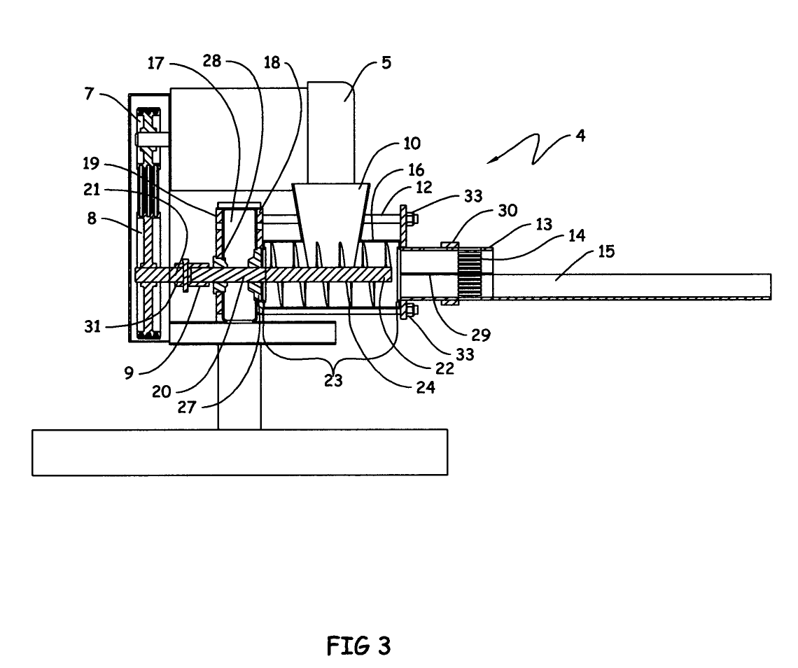

FIG. 4 is an enlarged side view of a portion B of the apparatus of FIG. 2 with the wheel missing from the front side to ensure clarity and showing a power take-off connection to the extruder screw.

FIG. 5 is an enlarged side view of a portion B of the apparatus of FIG. 2 with the wheels missing from the frame to ensure clarity and showing a gear box and gears.

### DETAILED DESCRIPTION OF THE INVENTION

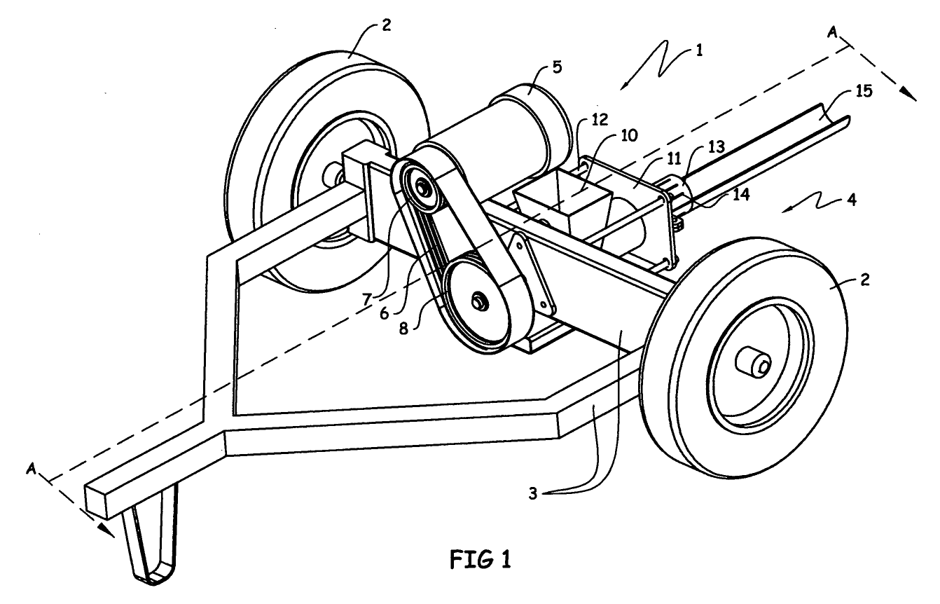

Turning now to FIG. 1 and a detailed description of the invention, there is shown an apparatus 1 that is a biomass densifier. The FIG. 1 apparatus is the preferred manner in which to make the apparatus 1 portable, although, it is not required to have wheels 2.

There is shown the frame 3, on which the extruder 4 is mounted. Shown in this Figure are an electric motor 5 (this motor can also be a fuel driven motor, such as a gasoline or diesel driven motor), drive belts 6 configured to a drive pulley 7 for the electric motor 5, a drive pulley 8 for the belts 6 on the shaft connector 9, a hopper 10 for feeding biomass to the extruder 4, a support plate 11 and support rods 12, and attached to the front of the plate 11 is a barrel 13 that has elongated openings 14 in it, and an extension 15 that is attached to the barrel 13 to aid in the removal of the densified mass from the barrel.

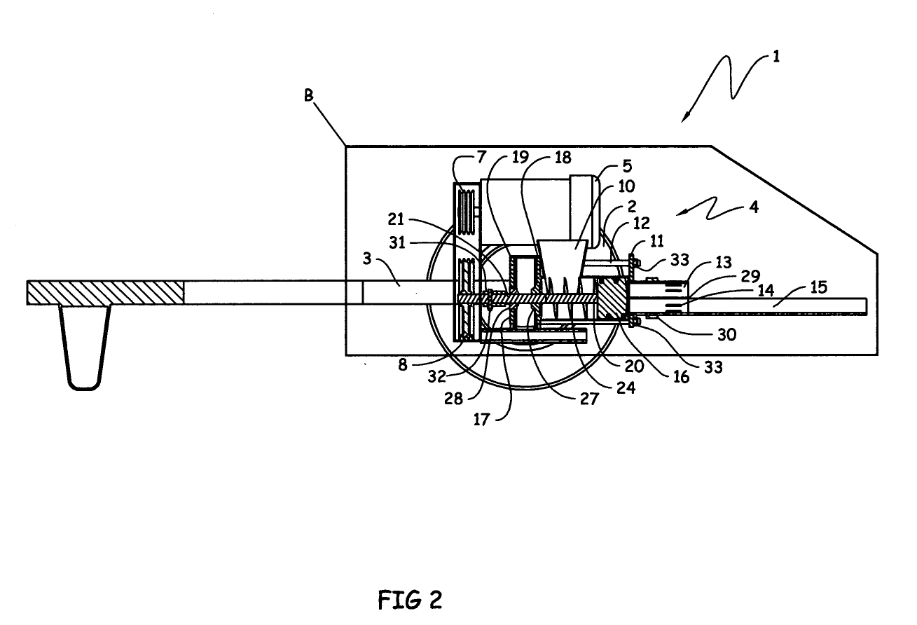

In more detail, and with reference to FIG. 2, there is shown the details of the extruder 4. The extruder 4 comprises an extruder housing 16, a bearing housing 17 adjacent the extruder housing 16, and in alignment therewith, a front wall 18 for the bearing housing 17 and a back wall 19 for the bearing housing 17.

The Extruder 4 also comprises a feed hopper 10 for feeding biomass to the extruder 4. The extruder housing 16 has mounted in it and supports an extruder shaft 20. The extruder shaft 20 has a first end 22 and a second end 21, the first end 22 being the lead end of the extruder shaft 20 and the second end 21 being the trailing or back end of the extruder shaft 20. The extruder shaft 20 has at its middle zone 23, an auger segment 24.

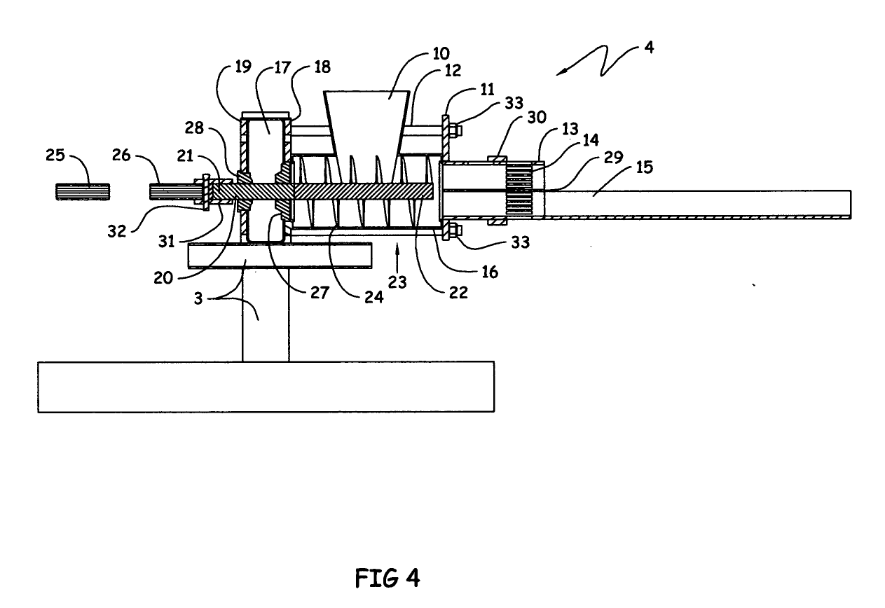

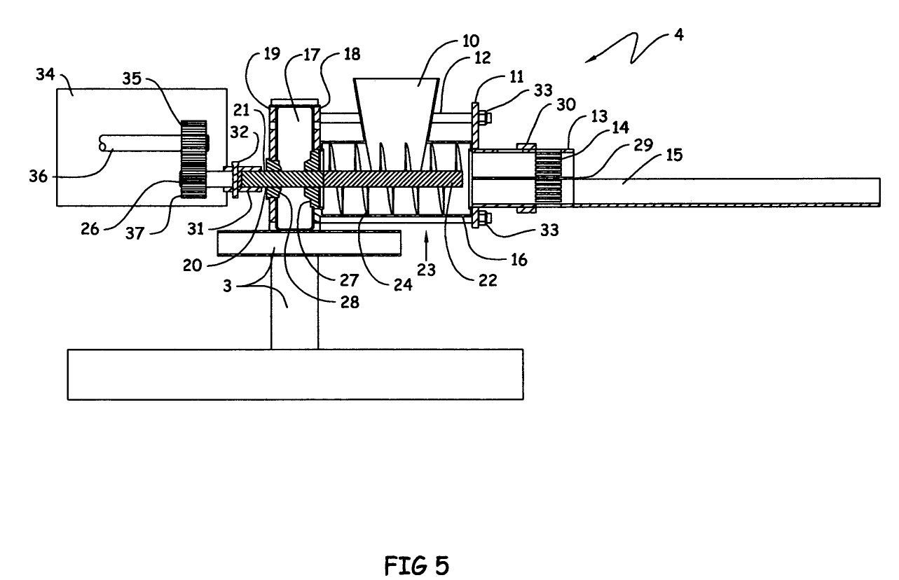

The first end 21 has mounted on it a means for connecting to a drive means. The drive means can be for example a motor, such as the electric motor 5 shown in FIG. 1, or it can be a motor that is gasoline or diesel driven. This connection is usually a belt 6 and pulley system 7 and 8 as described Supra. In addition, it is contemplated within the scope of this invention to use a power take-off drive means 25 shown in FIG. 4 wherein the connector for the power take-off means is shown as 26, or a gear box 34 with gears 35 and 37 as is shown in FIG. 5.

The extruder shaft 20 is supported near the first end 21 by a set of bearings, namely, a thrust bearing 27 and a roller bearing 28, all of which is housed in and supported by the bearing housing 17. The thrust bearing 27 is located near the front wall 18 of the bearing housing and the roller bearing 28 is located near the back wall 19 of the bearing housing 17.

Turning now to FIG. 4 and the vented barrel 13, which is the essence of this invention, there is shown the vented barrel 13, the elongated openings 14 and there is also shown a gap 29. The gap 29 is formed by placing two halves of the barrel together and leaving a small gap 29 to aid in the venting of the barrel 13. The barrel 13 can be made of more than two pieces of material, and in each case, the barrel 13 should have a gap where the pieces join together. It should be noted that the elongated openings 14 can be elongated or round or any other configuration as long as they allow the gasses to exit the barrel 13 conveniently. The vent openings can be spaced 1 to 1½ inches apart around the circumference of the barrel openings should be approximately about 1½ inches from the beginning of the barrel and extend to about 3 inches. It should also be noted that it is more efficient to place the openings 14 more in the forward end of the barrel 13.

As shown in FIG. 4, there is also a clamp 30 that surrounds the outside of the barrel 13 and holds the barrel 13 in the gapped configuration. As can be observed, the barrel 13 is held in place on the support wall 11 and the support wall 11 is supported by support rods 12 that are connected securely to the extruder housing 16/bearing housing 17 common wall (front wall 18 of the bearing housing 17) and the opposite end of the support rods 12 are held in place in the support wall 11 by fasteners, in this case as shown, threaded nuts 33. Both the bearing housing 17 and the extruder housing 16 are securely fastened to the frame 3.

It should be noted that the clamp 30 is configured such that the pressure exerted by the auger segment 24 of the extruder screw can be balanced such that there is some back pressure on the forming material, without the barrel 13 exploding and such that the pressure is sufficient to form the densified material according to the invention.

At the first end 22 of the extruder shaft 20 is a connector 31 that connects the connector for the drive means 26 to the extruder shaft 20. The connector 31 surrounds the ends of the extruder shaft 20 and the connector for the drive means 26 and is pinned in place by a shear pin 32. In the event that the extruder gets bogged down because of overload of material, the shear pin 32 will shear rather than twisting the shaft 20. The power take-off is conventional state of the art in power equipment and is not shown.

Turning now to FIG. 5, wherein like numbers indicate like components, there is shown a gear box 34 that contains within it, a drive gear 35 driven by a gear drive shaft 36. Also shown is a gear 37 that is used for driving the shaft 21, it being noted that gears 35 and 37 complement each other. The energy means for the drive shaft 36 is not shown and can be any conventional means for driving such shafts.

Comminuted, chipped, or otherwise small-sized biomass is fed into the hopper 10 with the extruder screw 20 operating, and the extruder screw 20 conveys the biomass towards the barrel 13 and slowly compresses the material. As the biomass material feeds into the barrel 13, it is further compacted such that it is densified and because of the vent holes in the barrel 13, the material is highly compressed. The apparatus of this invention can yield densities on the order of about 100 pounds/cubic foot, while prior art devices can produce materials having densities only in the range of about 70 pounds/cubic foot. As the biomass compresses, there is heat generated and this heat is sufficient under the pressures of the extruder to furnish the high density material while venting the gasses generated from such heating. Such temperatures can be as high as 160° C. No additional heating means is required.

It should be noted that even though the apparatus 1 of FIG. 1 is shown as essentially mounted in a horizontal position, it is contemplated within the scope of this invention to mount the apparatus at any angle convenient to use the apparatus, including a totally vertical mounting. Positioning the extruder in a vertical position allows for additional venting as the gasses can escape the apparatus upwardly from the auger face.

Biomass that is conventionally used in prior art devices can easily be used in the apparatus of the instant invention. Such materials as waste wood products, such as slashing, sawdust, bark, and the like, grasses, weeds, tree branches and twigs, leaves, grain stalks, grains, starch containing grain products, pine needles, pine cones, nut shells, and lumber scraps to mention a few.

The apparatus of this invention is lightweight and is portable to the extent that it can be moved from site to site and can accommodate clean up proceedings. The portability of the unit is such that it is economically maintainable. The portable nature of the device allows finished product to be manufactured in forest or field thus greatly reducing transportation costs. It reduces the cost of using wood chips by a factor of eight if the densification can be done on site where the chips are produced. The high wear components can easily be replaced in the field for efficient maintenance.

What is claimed is:

1. A densifying apparatus for densifying biomass, said apparatus comprising in combination a support frame and mounted to said support frame, an extruder, said extruder having
(i) an extruder housing;
(ii) a bearing housing having a front wall and a back wall;
(iii) a feed hopper;
(iv) a vented barrel having a long axis,
said extruder housing having mounted and supported therein, an extruder screw, said extruder screw comprising:
a) an extruder shaft;
b) an auger segment mount on a;
c) a first end,
d) a second end, and
e) a middle zone;
said extruder shaft having mounted on the first end, a means for connecting to a drive means, and said extruder shaft terminating near the second end;
said auger segment mounted near the middle zone;
said bearing housing being located between the extruder housing and the first end of the extruder shaft and said extruder shaft being supported by a thrust bearing located near the bearing housing front wall and a roller bearing located near the bearing housing back wall;
said vented barrel being mounted on a support wall and being centered around the extruder shaft, the vent barrel being in linear alignment along the long axis with the extruder shaft;
(v) a pressure clamp encircling the vented barrel;
said hopper mounted on the extruder housing such that the biomass can be delivered to the auger segment of the extruder screw.

2. The apparatus as claimed in claim 1 wherein the drive means is a motor having a shaft and having mounted thereon, a drive pulley, the motor being mounted on the support frame, the second end of the extruder shaft having mounted thereon a drive pulley, and wherein the motor pulley and the drive pulley are connected with at least one drive belt.

3. The apparatus as claimed in claim 1 wherein the drive means is a power take-off from power equipment.

4. The apparatus as claimed in claim 1 wherein the extruder shaft is comprised of two pieces, wherein the two pieces are attached to each other in a linear alignment, end to end, and the attachment means is a clamp having a shear pin to hold the attachment means together.

5. The apparatus as claimed in claim 1 wherein the vented barrel is a split barrel having at least two segments.

6. The apparatus as claimed in claim 1 wherein the vented barrel has an extension at the outlet end of the vented barrel.

7. The apparatus as claimed in claim 1 wherein the support frame has, in addition, wheels attached thereto for transportation purposes.

8. The apparatus as claimed in claim 1 that is mounted in a horizontal position on the support frame.

9. The apparatus as claimed in claim 1 that is mounted in a vertical position on the support frame.

10. The apparatus as claimed in claim 1 that has elongated slits in the vented barrel.

11. The apparatus as claimed in claim 1 that has elongated slits in the vented barrel and the split barrel has a gap at the splits.

12. The apparatus as claimed in claim 1 in which the vented barrel is round in configuration.

13. The apparatus as claimed in claim 1 in which the vented barrel is square in configuration.

14. The apparatus as claimed in claim 1 in which the vented barrel is diamond shaped in configuration.

15. A densified biomass material that has a density of 75 pounds per square foot or greater.
